(19) United States
(12) Patent Application Publication
(10) Pub. No.: US 2022/0161605 A1
(43) Pub. Date: May 26, 2022

(54) TIRE

(71) Applicant: Sumitomo Rubber Industries, Ltd., Kobe-shi (JP)

(72) Inventors: Yoshifumi KAWAGOE, Kobe-shi (JP); Koichi NAKAJIMA, Kobe-shi (JP); Yoshiaki KANEMATSU, Kobe-shi (JP); Hiroshi YAMAOKA, Kobe-shi (JP)

(73) Assignee: Sumitomo Rubber Industries, Ltd., Kobe-shi (JP)

(21) Appl. No.: 17/529,274

(22) Filed: Nov. 18, 2021

(30) Foreign Application Priority Data
Nov. 24, 2020 (JP) 2020-194509

(51) Int. Cl. B60C 11/12; B60C 11/01; B60C 11/03; B60C 11/04

(52) U.S. Cl. CPC B60C 11/1204; B60C 11/01; B60C 2011/0365; B60C 11/045; B60C 11/0304

(57) ABSTRACT

Provided is a tire including a tread portion. The tread portion can include a first shoulder land portion. The first shoulder land portion 11 can include a shoulder lateral groove and a shoulder sipe. The shoulder lateral groove can include a minimal portion in which a groove width of the shoulder lateral groove is smallest, between a ground contact surface and a groove bottom of the shoulder lateral groove. A width of the shoulder sipe may not be greater than 1.5 mm. An internal groove having a groove width greater than the width of the shoulder sipe can be continuously disposed inwardly of the shoulder sipe in a tire radial direction. The internal groove can be disposed inwardly of the minimal portion and outwardly of the groove bottom of the shoulder lateral groove, in the tire radial direction.

### CROSS-REFERENCE TO RELATED APPLICATION

The present application claims priority to Japanese patent application JP 2020-194509, filed on Nov. 24, 2020, the entire contents of which are incorporated herein by reference in its entirety.

### BACKGROUND

### Technical Field

The present disclosure relates to a tire.

### Description of the Background Art

Japanese Laid-Open Patent Publication No. 2019-188850 suggests a tire having, in a tread surface, grooves extending in the tire axial direction. In Japanese Laid-Open Patent Publication No. 2019-188850, the groove is described as including a minimal portion in which a groove width is locally smallest, in a portion tire-radially inward of an opening formed in the tread surface. The tire disclosed in Japanese Laid-Open Patent Publication No. 2019-188850 is described as exerting enhanced uneven-wear resistance and grip performance by the grooves in a well-balanced manner.

In general, in a case where a tread portion is worn, the volume of the groove formed in the tread portion or a groove width appearing on a ground contact surface may be reduced, so that balance between dry performance and wet performance tends to be degraded as compared with the balance at a time when the tire was new. Therefore, to date, the balance has been required to be maintained also in a state where the tread portion is worn.

The groove disclosed in Japanese Laid-Open Patent Publication No. 2019-188850 is described as having such a shape that, after the minimal portion has been exposed due to the tread portion being worn, the groove width at the ground contact surface is increased according to the tread portion being worn. According to Japanese Laid-Open Patent Publication No. 2019-188850, an effect of improving maintaining of the balance to some extent can be expected. However, in recent years, requirements for various performances of tires have been enhanced, and the balance can be required to be maintained in a further improved manner.

### SUMMARY

The present disclosure is directed to a tire including a tread portion. The tread portion can include a first tread end and a first shoulder land portion as a land portion including the first tread end. The first shoulder land portion can include a shoulder lateral groove and a shoulder sipe extending in a ground contact surface of the first shoulder land portion in a tire axial direction. The shoulder lateral groove can include a minimal portion in which a groove width of the shoulder lateral groove is smallest, between the ground contact surface and a groove bottom of the shoulder lateral groove. A width of the shoulder sipe may not be greater than 1.5 mm. An internal groove having a groove width greater than the width of the shoulder sipe can be continuously disposed inwardly of the shoulder sipe in a tire radial direction. The internal groove can be disposed inwardly of the minimal portion in the tire radial direction and outwardly of the groove bottom of the shoulder lateral groove in the tire radial direction.

### BRIEF DESCRIPTION OF THE DRAWINGS

FIG. 1 is a development of a tread portion of a tire according to one or more embodiments of the present disclosure;

FIG. 2 is an enlarged view of a first shoulder land portion shown in FIG. 1;

FIG. 3 is a cross-sectional view taken along a line A-A in FIG. 2;

FIG. 4 is a cross-sectional view taken along a line B-B in FIG. 2;

FIG. 5 is a cross-sectional view of a shoulder lateral groove of a comparative example; and

FIG. 6 is a cross-sectional view of a shoulder sipe of the comparative example.

### DESCRIPTION OF THE PREFERRED EMBODIMENTS

The present disclosure has been made in view of the aforementioned circumstances (and other circumstances) described in the Background section, and an object of the present disclosure (among other objects) can be to provide a tire that can maintain balance between dry performance and wet performance also when a tread portion is worn.

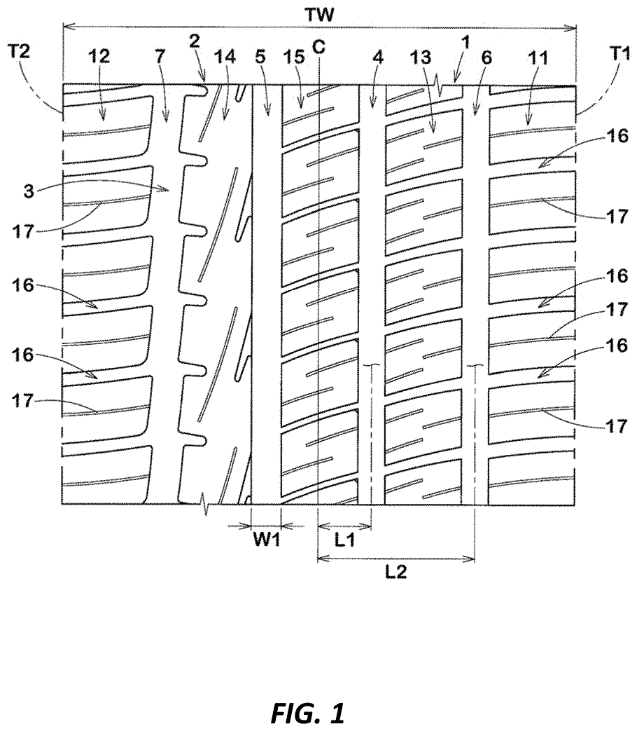

Embodiments of the present disclosure will be described below with reference to the drawings. FIG. 1 is a development of a tread portion 2 of a tire 1 according to one or more embodiments of the present disclosure. The tire 1 can be, for example, used as a pneumatic tire for passenger cars for all seasons. However, the tire 1 of embodiments of the present disclosure is not limited thereto.

For example, the tire 1 can have the tread portion 2 having a designated mounting direction to a vehicle. The mounting direction to a vehicle can be, for example, indicated as characters or a mark on a sidewall portion or the like. The tread portion 2 can be, for example, structured to have an asymmetric pattern (this can mean that the tread pattern is not line-symmetric about a tire equator C).

The tread portion 2 can include a first tread end T1 located on the inner side of the vehicle when the tire 1 is mounted to the vehicle and a second tread end T2 located on the outer side of the vehicle when the tire 1 is mounted to the vehicle. The first tread end T1 and the second tread end T2 each can correspond to the outermost ground contact position in the tire axial direction in the case of a normal load being applied to the tire 1 in a normal state and the tire 1 being in contact with a plane at a camber angle of 0°.

The “normal state” can represent a state in which a tire is mounted on a normal rim and is inflated to a normal internal pressure and no load is applied to the tire, when the tire is a pneumatic tire for which various standards are defined. For non-pneumatic tires and tires for which various standards are not defined, the normal state can represent a standard use state, corresponding to a purpose of use of the tire, in which no load is applied to the tire. In the description herein, unless otherwise specified, dimensions and the like of components of the tire are represented as values measured in the normal state.

The “normal rim” can represent a rim that is defined by a standard, in a standard system including the standard on which the tire is based, for each tire, and can be, for example, “standard rim” in the JATMA standard, “Design Rim” in the TRA standard, or “Measuring Rim” in the ETRTO standard.

The “normal internal pressure” can represent an air pressure that is defined by a standard, in a standard system including the standard on which the tire is based, for each tire, and can be, for example, “maximum air pressure” in the JATMA standard, the maximum value recited in the table “TIRE LOAD LIMITS AT VARIOUS COLD INFLATION PRESSURES” in the TRA standard, or “INFLATION PRESSURE” in the ETRTO standard.

The “normal load” can represent a load that is defined by a standard, in a standard system including the standard on which the tire is based, for each tire, and can be, for example, “maximum load capacity” in the JATMA standard, the maximum value recited in the table “TIRE LOAD LIMITS AT VARIOUS COLD INFLATION PRESSURES” in the TRA standard, or “LOAD CAPACITY” in the ETRTO standard, for the pneumatic tires for which various standards are defined. For non-pneumatic tires and tires for which various standards are not defined, the “normal load” can represent a load that acts on one tire in a standard mounting state of the tire. The “normal mounting state” can represent a state in which a tire is mounted to a standard vehicle corresponding to the purpose of use of the tire and the vehicle is stationary on a flat road surface in a state where the vehicle can run.

The tread portion 2 can include a plurality of circumferential grooves 3 continuously extending in the tire circumferential direction and a plurality of land portions demarcated by the circumferential grooves 3, between the first tread end T1 and the second tread end T2. As an example, the tire 1 can be structured as a so-called 5-rib tire in which the tread portion 2 includes five land portions demarcated by four circumferential grooves 3. However, embodiments of the present disclosure are not limited thereto. For example, the tire 1 may be structured as a so-called 4-rib tire in which the tread portion 2 includes three circumferential grooves 3 and four land portions.

The circumferential grooves 3 can include, for example, a first crown circumferential groove 4, a second crown circumferential groove 5, a first shoulder circumferential groove 6, and a second shoulder circumferential groove 7. The first crown circumferential groove 4 can be disposed between the tire equator C and the first tread end T1. The second crown circumferential groove 5 can be disposed between the tire equator C and the second tread end T2. The first shoulder circumferential groove 6 can be disposed between the first crown circumferential groove 4 and the first tread end T1. The second shoulder circumferential groove 7 can be disposed between the second crown circumferential groove 5 and the second tread end T2.

The circumferential groove 3 can be formed in various manners such that, for example, the circumferential groove 3 can zigzag or linearly extend in the tire circumferential direction.

A distance L1 from a groove center line of the first crown circumferential groove 4 or the second crown circumferential groove 5 to the tire equator C in the tire axial direction can be, for example, 5% to 15% of a tread width TW. A distance L2 from a groove center line of the first shoulder circumferential groove 6 or the second shoulder circumferential groove 7 to the tire equator C in the tire axial direction can be, for example, 25% to 35% of the tread width TW. However, the distances in embodiments of the present disclosure are not limited to such dimensions. The tread width TW can represent a distance in the tire axial direction from the first tread end T1 to the second tread end T2 in the normal state.

A groove width W1 of the circumferential groove 3 can be at least 3 mm. According to one or more embodiments, the groove width W1 of the circumferential groove 3 can be 3.0% to 7.0% of the tread width TW.

The land portions can include at least a first shoulder land portion 11. The first shoulder land portion 11 can be defined so as to be located outwardly of the first shoulder circumferential groove 6 in the tire axial direction, and can include the first tread end T1.

In this example, the land portions can include, in addition to the first shoulder land portion 11, a second shoulder land portion 12, a first middle land portion 13, a second middle land portion 14, and a crown land portion 15. The second shoulder land portion 12 can be defined so as to be located outwardly of the second shoulder circumferential groove 7 in the tire axial direction, and can include the second tread end T2. The first middle land portion 13 can be defined between the first shoulder circumferential groove 6 and the first crown circumferential groove 4. The second middle land portion 14 can be defined between the second shoulder circumferential groove 7 and the second crown circumferential groove 5. The crown land portion 15 can be defined between the first crown circumferential groove 4 and the second crown circumferential groove 5.

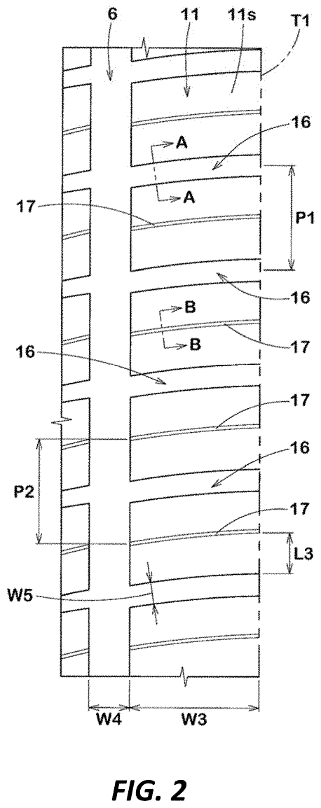

FIG. 2 is an enlarged view of the first shoulder land portion 11 of FIG. 1. As shown in FIG. 2, the first shoulder land portion 11 can have a shoulder lateral groove 16 and a shoulder sipe 17 extending in a ground contact surface 11s of the first shoulder land portion 11 in the tire axial direction.

In the description herein, the “sipe” can represent a cut element, having a small width, in which a width between two inner walls opposing each other is not greater than 1.5 mm. The width of the sipe can be 0.3 to 1.0 mm, for instance. A chamfered portion having a width of greater than 1.5 mm may be continuously formed at the opening of the sipe.

The shoulder lateral groove 16 and the shoulder sipe 17 can each connect to the first shoulder circumferential groove 6 and can extend across the first tread end T1. However, embodiments of the present disclosure are not limited thereto. The shoulder lateral groove 16 and the shoulder sipe 17 may have an end terminating in the ground contact surface of the first shoulder land portion 11.

Each of an angle of the shoulder lateral groove 16 relative to the tire axial direction and an angle of the shoulder sipe 17 relative to the tire axial direction can be, for example, not greater than 45°, for instance, not greater than 25°, such as not greater than 15°. A difference between the angle of the shoulder lateral groove 16 and the angle of the shoulder sipe 17 can be not greater than 5°, for instance. The shoulder lateral groove 16 and the shoulder sipe 17 can be disposed so as to be parallel to each other.

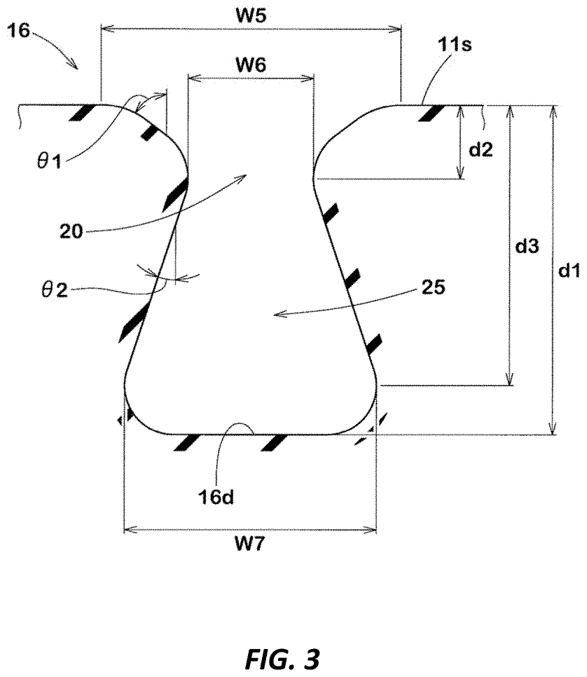

FIG. 3 is a cross-sectional view taken along a line A-A in FIG. 2. As shown in FIG. 3, the shoulder lateral groove 16 can have a minimal portion 20 in which a groove width of the shoulder lateral groove 16 is smallest, between the ground contact surface 11s of the first shoulder land portion 11 and a groove bottom of the shoulder lateral groove 16.

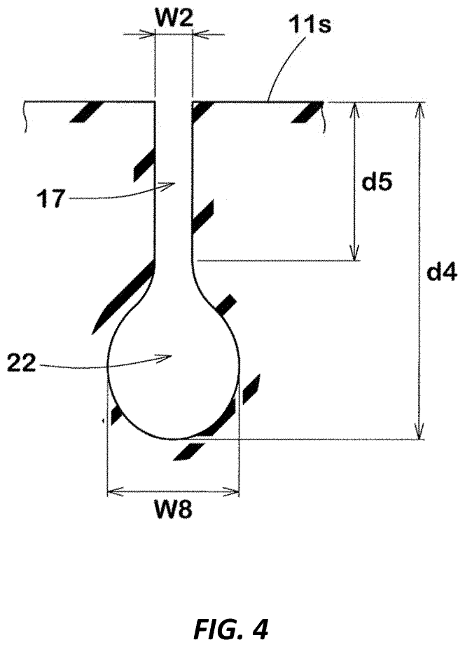

FIG. 4 is a cross-sectional view taken along a line B-B in FIG. 2. A width W2 of the shoulder sipe 17 can be not greater than 1.5 mm, for instance. An internal groove 22 having a groove width greater than the width W2 of the shoulder sipe 17 can be continuously disposed inwardly of the shoulder sipe 17 in the tire radial direction.

The internal groove 22 can be disposed inwardly of the minimal portion 20 in the tire radial direction and outwardly of a groove bottom 16d (shown in FIG. 3) of the shoulder lateral groove 16 in the tire radial direction. The tire 1 can have the above-described structure, for instance, so that balance between dry performance and wet performance can be maintained also when the tread portion 2 is worn. The following mechanism can be interpreted as a reason.

In the tire 1 of embodiments of the present disclosure, after the tread portion 2 is worn and the minimal portion 20 is exposed, the groove width of the shoulder lateral groove 16 at the ground contact surface 11s can be increased according to the tread portion being worn, thereby ensuring wet performance over a long time period. Furthermore, while the shoulder sipe 17 is exposed at the ground contact surface 11s, stiffness of the first shoulder land portion 11 can be maintained, to inhibit degradation of dry performance.

In a case where the wear of the tread portion 2 progresses, and a distance between the internal groove 22 and the ground contact surface can be reduced, the internal groove 22 can aid in drainage performance to inhibit wet performance from being excessively degraded. In one or more embodiments of the present disclosure, the internal groove 22 can be disposed inwardly of the minimal portion 20 in the tire radial direction and outwardly of the groove bottom 16d of the shoulder lateral groove 16 in the tire radial direction. Therefore, after the minimal portion 20 has been exposed, before the shoulder lateral groove 16 disappears due to the wear, the internal groove 22 can be exposed at the ground contact surface, so that degradation of wet performance can be assuredly inhibited. In the present disclosure, such a mechanism may be understood to allow balance between dry performance and wet performance to be maintained also when the tread portion 2 is worn.

The structure of embodiments of the present embodiment will be described below in more detail. The structures described below can represent a specific mode of one or more embodiments of the present disclosure. Therefore, needless to say, also when the structures described below are not included in the present disclosure, or one or more embodiments thereof, the above-described effects can be exhibited. Also when any one of the structures described below is applied alone to the tire of the present disclosure having the above-described features, improvement of performance corresponding to each structure can be expected. Furthermore, in a case where some of the structures described below are applied in combination, improvement of a combination of performances corresponding to the structures can be expected.

As shown in FIG. 2, the shoulder lateral grooves 16 and the shoulder sipes 17 can alternate in the tire circumferential direction. Each of one pitch length P1 of the shoulder lateral groove 16 in the tire circumferential direction and one pitch length P2 of the shoulder sipe 17 in the tire circumferential direction can be, for example, 70% to 100% of a width W3 of the first shoulder land portion 11 in the tire axial direction.

In the ground contact surface 11s of the first shoulder land portion 11, a distance L3 in the tire circumferential direction from an edge of the shoulder lateral groove 16 to an edge of the shoulder sipe 17 can be not less than 1.3 times a groove width W5 of the shoulder lateral groove 16 at the ground contact surface 11s, for instance, not less than 1.5 times the width W5, such as not less than 1.7 times the width W5, and can be not greater than 2.7 times the width W5, for instance, not greater than 2.5 times the width W5, such as not greater than 2.3 times the width W5. Such an arrangement of the shoulder lateral grooves 16 and the shoulder sipes 17 can contribute to well-balanced enhancement of dry performance and wet performance.

As shown in FIG. 3, at the ground contact surface of the first shoulder land portion 11, the groove width W5 of the shoulder lateral groove 16 can be, for example, 50% to 70% of a groove width W4 (shown in FIG. 2) of the first shoulder circumferential groove 6.

A maximal depth d1 of the shoulder lateral groove 16 can be, for example, 70% to 90% of the maximal depth of the first shoulder circumferential groove 6. However, the shoulder lateral groove 16, according to embodiments of the disclosed subject matter, is not limited thereto.

A depth d2 from the ground contact surface 11s to the minimal portion 20 can be, for example, less than 50% of the maximal depth d1 of the shoulder lateral groove 16. According to one or more embodiments, the depth d2 of the minimal portion 20 can be not greater than 40% of the depth d1, for instance, not greater than 30% thereof, such as not less than 5% thereof or not less than 10% thereof. Thus, the minimal portion 20 can be exposed at the ground contact surface 11s when wear of the tread portion 2 progresses to a moderation extent, and degradation of wet performance according to the tread portion being worn after that can be inhibited.

A groove width W6 of the minimal portion 20 can be, for example, 30% to 60% of the groove width W5 of the shoulder lateral groove 16 at the ground contact surface 11s and preferably 40% to 50% thereof. The minimal portion 20 having such a structure can contribute to maintaining of balance between dry performance and wet performance.

In a region from the ground contact surface 11s to the minimal portion 20, an angle θ1 of a groove wall of the shoulder lateral groove 16 relative to the normal to the tire can be, for example, 40 to 60°. Thus, at the start of use of the tire, the groove wall located outwardly of the minimal portion 20 in the tire radial direction can come into contact with a ground to a moderation extent according to increase of a ground contact pressure. In other words, the groove wall located outwardly of the minimal portion 20 in the tire radial direction can act as a chamfered portion, for instance, so that enhancement of traction performance or braking performance can be expected. In the first shoulder land portion 11 in which the shoulder lateral grooves 16 having such a structure are disposed, a ground contact pressure at the time of braking can be made more uniform, for instance, so that enhancement of uneven-wear resistance and reduction of a pattern noise in a worn state can be expected.

The shoulder lateral groove 16 can include a body portion 25 disposed inwardly of the minimal portion 20 in the tire radial direction. A maximal groove width W7 of the body portion 25 can be equal to the groove width W5 of the shoulder lateral groove 16 in the ground contact surface 11s or less than the groove width W5. The maximal groove width W7 of the body portion 25 can be, for example, 50% to 100% of the groove width W5 of the shoulder lateral groove 16 at the ground contact surface 11s, such as 70% to 100% thereof. Thus, in a state where the tread portion 2 has been worn to such an extent that a portion near a portion having the maximal groove width W7 is exposed, wet performance can be sufficiently exhibited.

Furthermore, the maximal groove width W7 of the body portion 25 can be, for example, not greater than 300% of the groove width W6 of the minimal portion 20, for instance, from 150% to 250% thereof (inclusive). Thus, wet performance can be sufficiently exhibited while molding defects generated in vulcanization molding can be reduced.

A depth d3 from the ground contact surface 11s to the position at which the body portion 25 has the maximal groove width W7 can be, for example, 80% to 90% of the maximal depth d1 of the shoulder lateral groove 16.

The body portion 25 can include a region in which a groove width is increased toward the inner side in the tire radial direction. An angle θ2 of a groove wall in this region relative to the normal to the tire can be less than the angle θ1, and can be, for example, 15 to 25°.

As shown in FIG. 4, a depth d4 from the ground contact surface 11s to the bottom of the internal groove 22 can be, for example, less than the maximal depth d1 of the shoulder lateral groove 16, and can be 70% to 90% of the depth d1, according to one or more embodiments of the present disclosure.

The shoulder sipe 17 can have, for example, a sipe wall that is continuous with the ground contact surface and that can extend parallel to the tire radial direction. A depth d5 of the shoulder sipe 17 can be, for example, greater than the depth d2 from the ground contact surface 11s to the minimal portion 20, and may not be greater than 300% of the depth d2. Specifically, the depth d5 of the shoulder sipe 17 can be not less than 150% of the depth d2, for instance, not less than 180% thereof, and can be not greater than 250% thereof, for instance, not greater than 220% thereof. Thus, after the minimal portion 20 of the shoulder lateral groove 16 has been exposed, the internal groove 22 can be exposed in a state where wear has progressed to some extent. Therefore, also when the tread portion is worn, balance between dry performance and wet performance can be maintained.

A maximal groove width W8 of the internal groove 22 can be, for example, not greater than 500% of the width W2 of the shoulder sipe 17. Specifically, the maximal groove width W8 of the internal groove 22 can be not less than 200% of the width W2 of the shoulder sipe 17, for instance, not less than 250% thereof, and can be not greater than 400%, for instance, not greater than 350% thereof. The internal groove 22 having such a structure can allow the above-described effect to be exhibited while allowing reduction of vulcanization molding defects.

A cross-sectional area of the internal groove 22 can be 10% to 50% of a cross-sectional area of the body portion 25 of the shoulder lateral groove 16, for instance. Thus, the internal groove 22 can sufficiently make up for drainage performance of the shoulder lateral groove 16.

As shown in FIG. 1, in one or more embodiments of the present disclosure, the shoulder lateral groove 16 and the shoulder sipe 17 described above can be disposed at least in the first shoulder land portion 11 disposed inwardly of the tire equator C on the vehicle inner side when the tire 1 is mounted to the vehicle. Optionally, the shoulder lateral groove 16 and shoulder sipe 17 described above can also be disposed in the second shoulder land portion 12. Thus, the above-described effects may be more assuredly exhibited.

Although the tire according to the above-described embodiment(s) of the present disclosure has been described above in detail, the present disclosure is not limited to the above-described specific embodiment(s), and various modifications can be made to implement the technique and/or configuration of the present disclosure.

### Examples

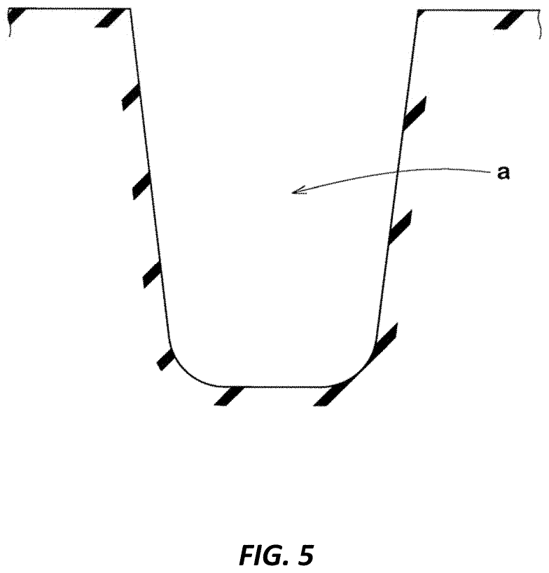

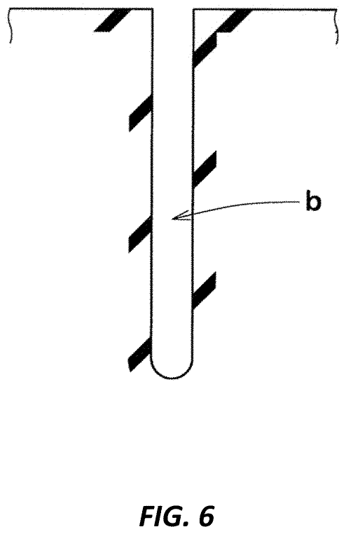

Tires having a pattern shown in FIG. 1 and a size of 275/40ZR20 were produced as sample tires according to the specifications indicated in Tables 1 and 2. As a comparative example, tires including a shoulder lateral groove a having a cross-sectional shape shown in FIG. 5 and a shoulder sipe b having a cross-sectional shape shown in FIG. 6 were produced as sample tires. The tire of the comparative example had substantially the same structure as the tire shown in FIG. 1 except for the above-described structure. Each test tire was tested for dry performance and wet performance at the initial stage of use, wet performance in a worn state, and balance between dry performance and wet performance in the worn state. The specifications common to the test tires and the test method were as indicated below.

Rim on which the tire was mounted: 20×9.5J

Tire internal pressure: 220 kPa at all wheels

Test vehicle: rear-wheel-drive car having an engine displacement of 3500 cc

Positions at which the tires were mounted: all wheels

<Dry Performance and Wet Performance at Initial Stage of Use>

The test vehicle was used, and a driver made sensory evaluation for performance when the vehicle was caused to run on a dry road surface or a wet road surface at the initial stage of use of the tire. The results are indicated as scores with the performances of the comparative example being 100. The greater the value is, the more excellent dry performance or wet performance is.

<Wet Performance in Worn State>

The test vehicle was used, and a driver made sensory evaluation for performance when the vehicle was caused to run on a wet road surface in a state where a groove depth of the shoulder lateral groove was worn by 50% as compared with a groove depth at a time when the tire was new. The results are indicated as scores with the performance of the comparative example being 100. The greater the value is, the more excellent wet performance in a worn state is.

<Balance Between Dry Performance and Wet Performance in Worn State>

The test vehicle was used, and was caused to run on a dry road surface and a wet road surface in a state where a groove depth of the shoulder lateral groove was worn by 50% as compared with a groove depth at a time when the tire was new, and balance between dry performance and wet performance was evaluated. The results are indicated as scores with the balance in the comparative example being 100. The greater the value is, the more excellent the balance is. The test results are indicated in Tables 1 and 2.

TABLE 1

| | Comp. | | | | | | | | |
|---|---|---|---|---|---|---|---|---|---|
| | Ex. | Ex. 1 | Ex. 2 | Ex. 3 | Ex. 4 | Ex. 5 | Ex. 6 | Ex. 7 | Ex. 8 |
| Figure showing cross-section of | FIG. 5 | FIG. 3 | FIG. 3 | FIG. 3 | FIG. 3 | FIG. 3 | FIG. 3 | FIG. 3 | FIG. 3 |
| shoulder lateral groove | | | | | | | | | |
| Figure showing cross-section of | FIG. 6 | FIG. 4 | FIG. 4 | FIG. 4 | FIG. 4 | FIG. 4 | FIG. 4 | FIG. 4 | FIG. 4 |
| shoulder sipe | | | | | | | | | |
| Maximal groove width W7 of body | — | 85 | 70 | 80 | 90 | 100 | 85 | 85 | 85 |
| portion/groove width W5 of | | | | | | | | | |
| shoulder lateral groove (%) | | | | | | | | | |
| Maximal groove width W7 of body | — | 200 | 200 | 200 | 200 | 200 | 150 | 180 | 220 |
| portion/groove width W6 of minimal | | | | | | | | | |
| portion (%) | | | | | | | | | |
| Maximal groove width W8 of | — | 350 | 350 | 350 | 350 | 350 | 350 | 350 | 350 |
| internal groove/width W2 of | | | | | | | | | |
| shoulder sipe (%) | | | | | | | | | |
| Depth d5 of shoulder sipe/depth d2 | — | 200 | 200 | 200 | 200 | 200 | 200 | 200 | 200 |
| of minimal portion (%) | | | | | | | | | |
| Dry performance at initial stage of | 100 | 100 | 100 | 100 | 99 | 97 | 102 | 100 | 99 |
| use (score) | | | | | | | | | |
| Wet performance at initial stage of | 100 | 105 | 101 | 103 | 106 | 107 | 102 | 104 | 105 |
| use (score) | | | | | | | | | |
| Wet performance in worn state | 100 | 110 | 105 | 107 | 112 | 113 | 106 | 108 | 111 |
| (score) | | | | | | | | | |
| Balance between dry performance | 100 | 110 | 106 | 108 | 109 | 107 | 107 | 108 | 109 |
| and wet performance in worn state | | | | | | | | | |
| (score) | | | | | | | | | |

TABLE 2

| | Ex. 9 | Ex. 10 | Ex. 11 | Ex. 12 | Ex. 13 | Ex. 14 | Ex. 15 | Ex. 16 | Ex. 17 |
|---|---|---|---|---|---|---|---|---|---|
| Figure showing cross-section of | FIG. 3 | FIG. 3 | FIG. 3 | FIG. 3 | FIG 3 | FIG 3 | FIG. 3 | FIG 3 | FIG. 3 |
| shoulder lateral groove | | | | | | | | | |
| Figure showing cross-section of | FIG. 4 | FIG. 4 | FIG. 4 | FIG. 4 | FIG 4 | FIG 4 | FIG. 4 | FIG 4 | FIG. 4 |
| shoulder sipe | | | | | | | | | |
| Maximal groove width W7 of body | 85 | 85 | 85 | 85 | 85 | 85 | 85 | 85 | 85 |
| portion/groove width W5 of | | | | | | | | | |
| shoulder lateral groove (%) | | | | | | | | | |
| Maximal groove width W7 of body | 250 | 200 | 200 | 200 | 200 | 200 | 200 | 200 | 200 |
| portion/groove width W6 of | | | | | | | | | |
| minimal portion (%) | | | | | | | | | |
| Maximal groove width W8 of | 350 | 250 | 300 | 400 | 450 | 350 | 350 | 350 | 350 |
| internal groove/width W2 of | | | | | | | | | |
| shoulder sipe (%) | | | | | | | | | |
| Depth d5 of shoulder sipe/depth d2 | 200 | 200 | 200 | 200 | 200 | 150 | 180 | 220 | 250 |
| of minimal portion (%) | | | | | | | | | |
| Dry performance at initial stage of | 98 | 100 | 100 | 100 | 98 | 100 | 100 | 100 | 99 |
| use (score) | | | | | | | | | |
| Wet performance at initial stage of | 106 | 103 | 104 | 105 | 105 | 103 | 104 | 105 | 105 |
| use (score) | | | | | | | | | |
| Wet performance in worn state | 113 | 105 | 107 | 111 | 113 | 108 | 109 | 111 | 111 |
| (score) | | | | | | | | | |
| Balance between dry performance | 108 | 106 | 108 | 109 | 107 | 108 | 109 | 110 | 109 |
| and wet performance in worn state | | | | | | | | | |
| (score) | | | | | | | | | |

As indicated in Tables 1 and 2, for the tires of the examples, scores for “balance between dry performance and wet performance in worn state” were high. That is, according to embodiments of the present disclosure, the balance was confirmed to be maintained.

Specifically, according to Tables 1 and 2, the following results can be confirmed. That is, in the examples, the scores for “dry performance at initial stage of use” were 97 to 102 points. In the examples, the scores for “wet performance at initial stage of use” were 101 to 107 points. In the examples, the scores for “wet performance in worn state” were 105 to 113 points. It can be understood that, as compared with the comparative example, the wet performance in a worn state was significantly maintained. As described above, in a conventional art, wet performance can be degraded according to the tire being worn, so that balance between dry performance and wet performance is degraded. However, in the tire of each example, it was confirmed that degradation of wet performance was small also in a worn state and balance between dry performance and wet performance in a worn state was maintained.

In the tire of one or more embodiments of the present disclosure, the shoulder lateral groove can extend across the first tread end.

In the tire of one or more embodiments of the present disclosure, the shoulder sipe can extend across the first tread end.

In the tire of one or more embodiments of the present disclosure, the shoulder lateral groove can include a body portion disposed inwardly of the minimal portion in the tire radial direction, and a maximal groove width of the body portion can be less than the groove width of the shoulder lateral groove in the ground contact surface.

In the tire of one or more embodiments the present disclosure, in the ground contact surface of the first shoulder land portion, a distance in a tire circumferential direction from an edge of the shoulder lateral groove to an edge of the shoulder sipe can be 1.3 to 2.7 times the groove width of the shoulder lateral groove.

In the tire of one or more embodiments of the present disclosure, the tread portion preferably can have a designated mounting direction to a vehicle, and the first shoulder land portion can be disposed inwardly of a tire equator on a vehicle inner side when the tire is mounted to the vehicle.

The tire of embodiments of the present disclosure can have the above-described structure, so that balance between dry performance and wet performance can be maintained also when the tread portion is worn.

What is claimed is:

1. A tire comprising:
a tread portion,
wherein the tread portion includes a first tread end and a first shoulder land portion as a land portion including the first tread end,
wherein the first shoulder land portion includes a shoulder lateral groove and a shoulder sipe extending in a ground contact surface of the first shoulder land portion in a tire axial direction,
wherein the shoulder lateral groove includes a minimal portion in which a groove width of the shoulder lateral groove is smallest, between the ground contact surface and a groove bottom of the shoulder lateral groove,
wherein a width of the shoulder sipe is not greater than 1.5 mm,
wherein an internal groove having a groove width greater than the width of the shoulder sipe is continuously disposed inwardly of the shoulder sipe in a tire radial direction, and
wherein the internal groove is disposed inwardly of the minimal portion in the tire radial direction and outwardly of the groove bottom of the shoulder lateral groove in the tire radial direction.

2. The tire according to claim 1, wherein the shoulder lateral groove extends across the first tread end.

3. The tire according to claim 1, wherein the shoulder sipe extends across the first tread end.

4. The tire according to claim 1,
wherein the shoulder lateral groove includes a body portion disposed inwardly of the minimal portion in the tire radial direction, and
wherein a maximal groove width of the body portion is less than the groove width of the shoulder lateral groove in the ground contact surface.

5. The tire according to claim 1, wherein, in the ground contact surface of the first shoulder land portion, a distance in a tire circumferential direction from an edge of the shoulder lateral groove to an edge of the shoulder sipe is 1.3 to 2.7 times the groove width of the shoulder lateral groove.

6. The tire according to claim 1,
wherein the tread portion has a designated mounting direction to a vehicle, and
wherein the first shoulder land portion is disposed inwardly of a tire equator on a vehicle inner side when the tire is mounted to the vehicle.

7. The tire according to claim 1, wherein the shoulder lateral groove includes a region in which a groove width increases from the minimal portion toward the groove bottom.

8. The tire according to claim 7, wherein the groove width of the region increases toward an inner side of the tire in the tire radial direction.

9. The tire according to claim 7, wherein an angle of a groove wall in the region relative to normal is 15 to 25 degrees.

10. The tire according to claim 1, wherein a first maximum depth from the ground contact surface to a bottom of the internal groove is less than a second maximum depth from of the shoulder lateral groove from the ground contact surface to the groove bottom of the shoulder lateral groove.

11. The tire according to claim 10, wherein the first maximum depth is 70% to 90% of the second maximum depth.

12. The tire according to claim 1, wherein a third maximum depth of the shoulder sipe is greater than a fourth maximum depth of the shoulder lateral groove from the ground contact surface to the minimal portion.

13. The tire according to claim 12, wherein the third maximum depth of the shoulder sipe is 150% to 300% of the fourth maximum depth.

14. The tire according to claim 1,
wherein the shoulder lateral groove includes a region in which a groove width increases from the minimal portion toward the groove bottom,
wherein a first cross-sectional area of the region is greater than a second cross-sectional area of the internal groove.

15. The tire according to claim 14, wherein the second cross-sectional area of the internal groove is 10% to 50% of the first cross-sectional area of the region.
